(19) United States
(12) Patent Application Publication
(10) Pub. No.: US 2025/0187096 A1
(43) Pub. Date: Jun. 12, 2025

(54) Welding wire supply system

(71) Applicant: AWDS TECHNOLOGIES SRL, ROVERETO (TN) (IT)

(72) Inventors: Filippo Corradini, ROVERETO (TN) (IT); Carlo Gelmetti, ROVERETO (TN) (IT)

(21) Appl. No.: 18/537,248

(22) Filed: Dec. 12, 2023

(51) Int. Cl. B23K 9/133; B65H 51/20

(52) U.S. Cl. CPC B23K 9/1336; B65H 51/20; B65H 2701/36

(57) ABSTRACT

A welding wire supply system has a first wire feeder and a wire guide for guiding the welding wire to an automated welding system with a second wire feeder and a welding torch. The wire guide includes a wire buffer arranged downstream of the first wire feeder. The wire buffer is adapted for receiving an additional length of welding wire in the path of the wire guide.

The invention relates to a welding wire supply system.

### BACKGROUND OF THE INVENTION

Welding wire supply systems are commonly used for feeding welding wires from a supply source, for example a container in which a significant amount (up to several hundred kilograms) of welding wire is being stored, to a point called welding arc where the welding wire is being melt through a welding torch, with the purpose of joining metal parts. Since the welding torch is usually connected to a welding robot and continuously moving, the welding wire has to be fed through a wire guiding liner from the container to the welding torch. The passing of the welding wire through the inevitable bends and curvatures on the wire guiding liner necessarily creates a certain amount of friction and drag. More curves along the wire guiding liner can worsen the problem to the point that it becomes very difficult for the wire feeding system to function properly and to guarantee the necessary smooth feeding.

In conventional welding applications, a single feeding device pulls the wire from the container and feeds it to the welding torch and it is placed between the wire source (the container) and the welding torch. In some other welding applications the feeding device itself contains the wire source in the form of a small spool and feeds the wire to the welding torch.

In robotic and automated applications, which are designed to maximize the productivity, the trend goes towards using large bulk packs containing from few hundred kilograms to more than one ton of welding wire. These bulk containers have to be positioned in a safe area at a significant distance from the device feeding the welding wire to the welding torch and preferably on the floor in a location that can be easily accessed by a forklift. In order to comply with increasingly stricter safety regulations and standards, it is strongly advisable to refrain from placing containers with welding wire high on top of traveling robots, where the maneuver of replacing a used pack with a new one can represent a serious hazard for the robot operators and weight tolerances would only permit the use of containers carrying a limited quantity of welding wire. Placing the packs at the floor undoubtedly offers the significant advantages of making it possible to use heavier containers with more product, for a maximized downtime saving, and of working in a safer environment but it can result in the welding wire having to be pulled over significant distances by the front feeder device from bulk containers towards the welding torch.

Transporting and feeding welding wire over long distances, preferably through guiding liners placed for convenience inside the cable drag chains, is not an easy task and often the main pulling wire feeder close to the welding torch is not capable of reliably advancing the welding wire. To assist the front pulling feeder, systems are known which use the combined action of a so-called master feeder (the wire feeding device close to the welding torch) and a so-called slave wire feeder (a second auxiliary wire feeder installed remotely from the welding torch, close to the wire supply bulk container).

The slave feeder can be an active feeder, meaning that its pushing action is actively started and stopped depending from the operation of the welding torch, or a passive feeder, meaning that is continuously pushes the welding wire when the resistance is below a certain threshold, stops pushing when the threshold is exceeded, and re-starts pushing when the resistance again drops below the threshold.

In some welding applications, it is necessary to quickly retract the welding wire into the welding torch when the welding operation is being stopped. This is a problem in particular when the slave feeder is a passive feeder. Even assuming that the passive feeder quickly stops pushing the wire, a certain length of welding wire (up to 100 mm) is pushed backwards into the welding guide from the master feeder. At least for soft welding wires such as aluminum wires, there is a risk that the welding wire is deformed which might cause an interruption of the welding process. This wire deformation is technically called “bird-nesting” and it can involve a significant downtime and loss of production because the wire has to be pulled out of the wire feeding system and re-inserted after the deformed section has been completely removed.

The object of the invention is to provide a wire supply system which prevents that the welding wire is being damaged in a situation in which the welding torch and the main feeder retract the welding wire from the welding torch.

### BRIEF DESCRIPTION OF THE INVENTION

In order to solve this problem, the invention provides a welding wire supply system, having a first wire feeder and a wire guide for guiding the wire to an automated welding system with a second wire feeder and a welding torch, the wire guide including a wire buffer arranged downstream of the first wire feeder, the wire buffer being adapted for receiving an additional length of welding wire in the path of the wire guide. The invention is based on the concept of providing a free space within the wire path from the first wire feeder (the slave feeder) to the second wire feeder (the master feeder), this free space receiving the lengths of welding wire which is being pushed backwardly into the wire path by the second wire feeder when the welding process is being stopped. As the welding wire can be freely received within the free space provided by the buffer, there is no risk that the welding wire is being deformed and subsequently damaged.

Preferably, the buffer comprises a receiving space between two attachment points for a first and a second wire guide element. The attachment points allow attaching a conduit to the buffer so that there is a complete, predefined wire path.

According to a preferred embodiment, the attachment points are pivot attachments for attaching the first and second wire guide elements. Attaching the first and second wire guide elements in a pivotable manner ensure that the wire guide elements are always perfectly aligned so that there is no bending stress on the welding wire.

According to a preferred embodiment, the buffer comprises a guiding surface for guiding the welding wire when a traction force is present in the welding wire between the first and second attachment points. The guiding surface here acts as a wire guide and defines the lengths of the welding wire path from the first feeder to the second feeder.

The guiding surface is preferably formed on a base body, the receiving space being defined by at least one bracket attached to the base body together with the guiding surface. The bracket encloses the receiving space on three sides so that the welding wire is reliably guided when being pushed backwardly into the receiving space.

The bracket can be adjustably attached to the base body so that it can assume a compact transport position and an extended operating position in which the receiving space is defined.

A plurality of positions of the bracket relative to the base body can be predefined by a plurality of recesses in the bracket so that an adjustment can be easily make in the different positions.

For attaching the base body to the bracket, at least one screw can be used so that a change of the position of the bracket with respect to the base body can be easily made.

According to a preferred embodiment, three brackets are evenly arranged between the attachment points for the first and second wire guide element. It is not necessary to provide a receiving space which is fully enclosed in a mechanical manner. Rather, a couple of spaced elements such that the brackets are sufficient so that the weight of the buffer is reduced.

In an alternative embodiment, the buffer can also comprise a slide allowing adjacent ends of the first and second wire guide elements to move from an approached working position to a spaced buffering position. Allowing a relative movement of two adjacent ends of the wire guide is an alternative way of making available an additional length in the wire path for receiving the welding wire when it is being pushed backwardly by the second feeder.

Preferably, the buffer comprises a cover which prevents that dust and other contaminations enter into the wire guide so that a low-friction transport of the welding wire is ensured.

The buffer preferably comprises mountain openings for mounting the base body in one of at least two positions, allowing to fit the buffer in a flexible manner according to the needs and the space which is available.

The first wire feeder is preferably associated with a welding wire container so that the welding wire can be supplied over longer distances from the welding wire container to the welding torch.

In an embodiment of the invention, the first wire feeder is a passive wire feeder so that no electrical control or connection to the welding system is required, making the installation of the system easier.

### BRIEF DESCRIPTION OF THE DRAWINGS

The invention will now be described with reference to the enclosed drawings. In the drawings,

FIG. 1 shows a wire supply system according to a first embodiment of the invention,

FIG. 2 shows a wire supply system according to a second embodiment of the invention,

FIG. 3 shows a wire supply system according to a third embodiment of the invention,

FIG. 4 shows a wire buffer as used in a wire supply system according to the invention, with the welding wire being in an operating condition,

FIG. 5 shows the wire buffer of FIG. 4, with the welding wire being in a buffered condition,

FIG. 6 shows a side view of the buffer as used in a wire supply system according to the invention, with the buffer being in a transport condition,

FIG. 7 shows detail VII of FIG. 6 at an enlarged scale,

FIG. 8 shows a perspective view of the buffer of FIG. 6 in a first intermediate condition,

FIG. 9 shows the buffer of FIG. 6 in a second intermediate condition,

FIG. 10 shows the buffer of FIG. 6 in a third intermediate condition,

FIG. 11 shows detail XI of FIG. 10 at an enlarged scale,

FIG. 12 shows the wire buffer as used in a wire supply system according to the invention in a fourth intermediate condition,

FIG. 13 shows the wire buffer of FIG. 12 in a different view, and

FIG. 14 shows the wire buffer of FIG. 12 in a still further view.

### DETAILED DESCRIPTION OF THE INVENTION

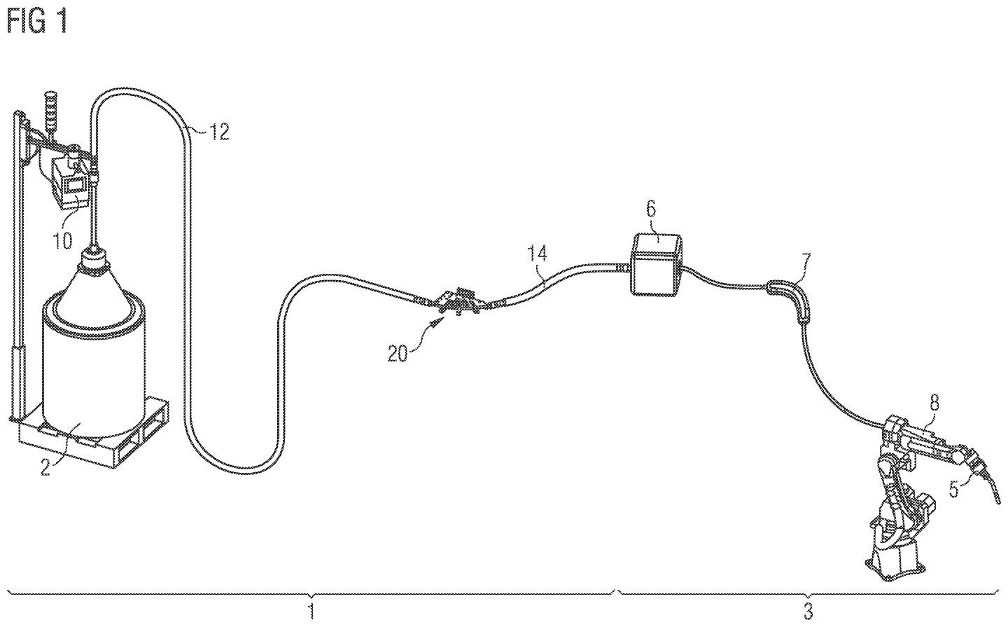

FIG. 1 shows a supply system 1 for a supplying welding wire from a container 2 to a welding torch system 3. The welding wire supplies system 1 comprises a wire feeder 10 withdrawing the welding wire from container 2 and pushes it through a wire guide to the welding torch system 3.

Wire feeder 10 can be referred to as the first feeder as it is, in the direction in which the welding wire is being advanced, the first feeder. In the shown embodiment, it is a passive wire feeder which pushes the welding wire into the wire guide until it detects a resistance which is above a predefined threshold. Then, the passive feeder 10 stops pushing the welding wire into the wire guide. As soon as the resistance drops below the threshold, the passive wire feeder 10 resumes its feeding action.

The welding torch system 3 here comprises a welding torch 5, a master feeder 6 and an intermediate wire sensing element 7 used for controlling the master feeder 6 depending on a torch feeder 8.

“Passive” in terms of the wire feeder 10 means that the feeder is a stand-alone feeder whose pushing action is not controlled or synchronized with the master feeder 6. The wire feeder 10 can be an electrically driven feeder (having an AC motor or a brushless motor), or it can be pneumatically driven (by compressed air which drives a turbine).

The wire guide is here formed from a first wire guide element 12 and a second wire guide element 14.

The upstream end of the wire guide is here the first end of the first wire guide element 12 which is connected to the first wire feeder 10. The downstream end of the wire guide is here the second end of the second wire guide element 14 which is connected to the master feeder 6.

Between the first and the second wire guide elements 12, 14, a buffer 20 is arranged. Generally speaking, the function of the buffer 20 is to provide a free space which can receive some welding wire in the wire guide path from the passive feeder 10 towards the master feeder 6.

In some welding applications, welding wire has to be retracted from the welding torch 5 when the welding operation is stopped. When welding wire is being retracted from the welding torch 5, it is pushed back (opposite to the feeding direction from the container 2 towards the welding torch 5) into the wire guide. This is done by simultaneous reverse operation of the master feeder 6 and the torch feeder 8. This length of the retracted welding wire can be up to 100 mm.

Pushing a certain length of the welding wire backwardly into the wire guide involves the risk that the welding wire is being damaged. This risk is particularly high when using aluminium welding wire which has a low strength. For such wire, the elasticity of the components forming the wire supply system might not be sufficient to accommodate the lengths of the welding wire being pushed backwardly into the wire guide without involving the risk of the welding wire being damaged.

As can be seen in FIG. 1, the buffer 20 is arranged between the first wire guide element 12 and the second wire guide element 14 of the welding wire at a point where it is closer to the master feeder 6 than to the first feeder 10.

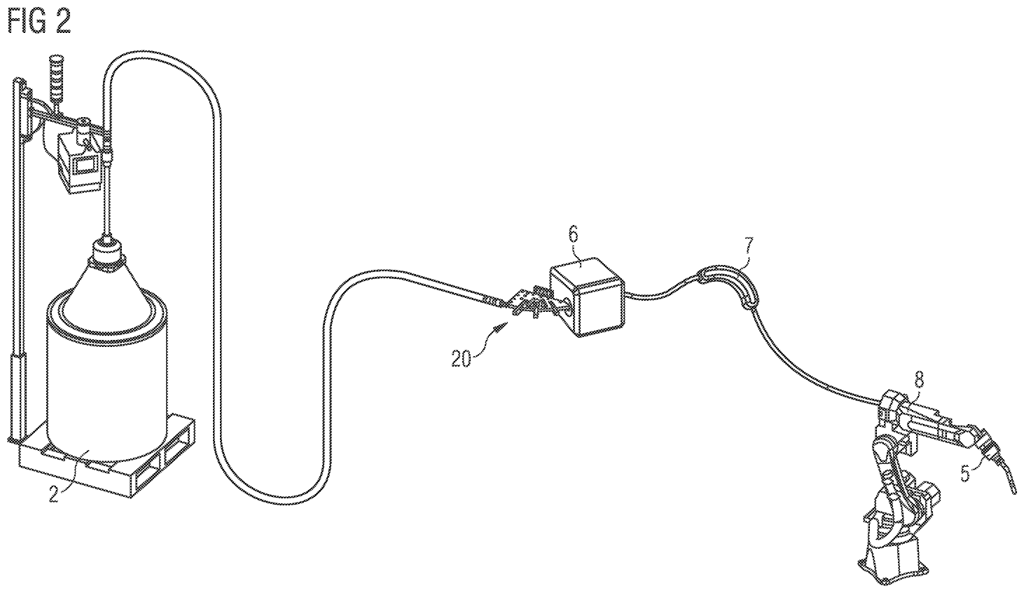

In the embodiment of FIG. 2, buffer 20 is arranged at the end of the wire supply system so that a single wire guide element 12 is used which extends from the passive wire feeder 10 to buffer 20.

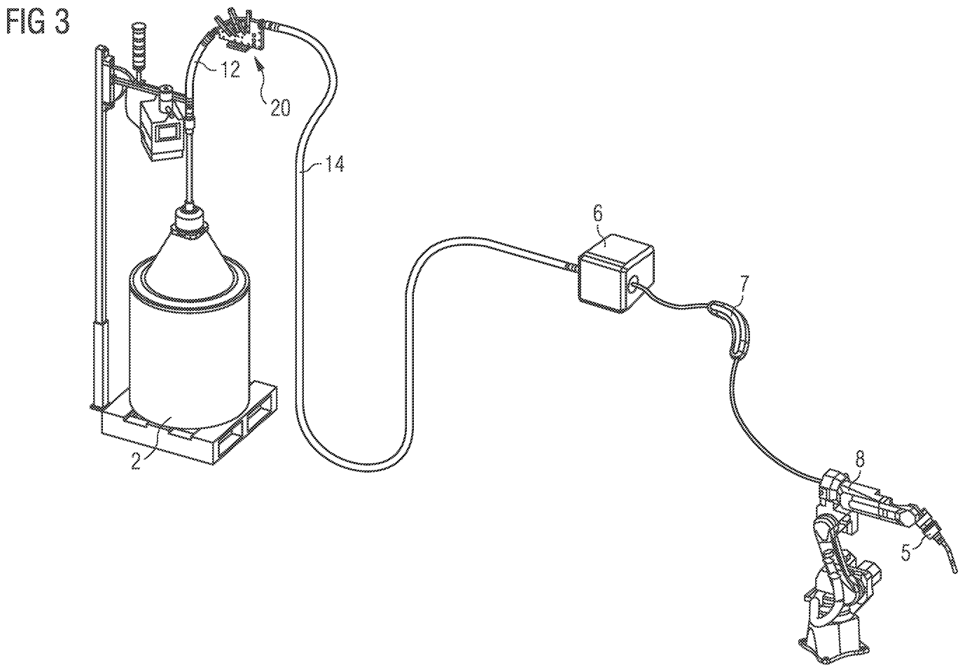

In the embodiment of FIG. 3, buffer 20 is arranged closer to the first feeder 10 than in the first embodiment so that a very short first wire guide element 12 and a very long second wire guide element 14 are used.

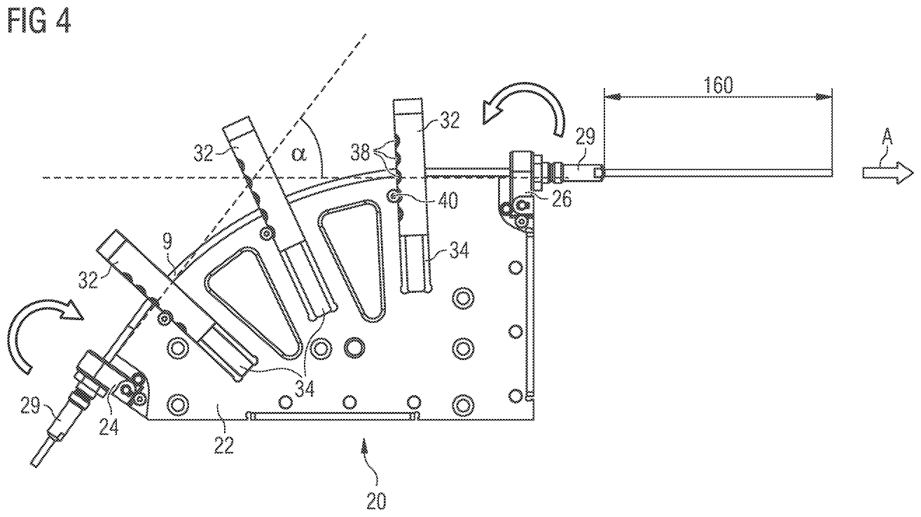

In FIG. 4, an embodiment of buffer 20 is shown. It comprises a base body, 22 which can be made from a plastic material. Base body 22 can have a length of approximately 300 mm and a height of approximately 200 mm.

Buffer 20 has a first attachment point 24 for receiving a wire guide element, and a second attachment point 26 for either receiving a second wire guide element (in the embodiment of FIGS. 1 and 3) or for being attached to the master feeder 6 associated with the welding torch 5.

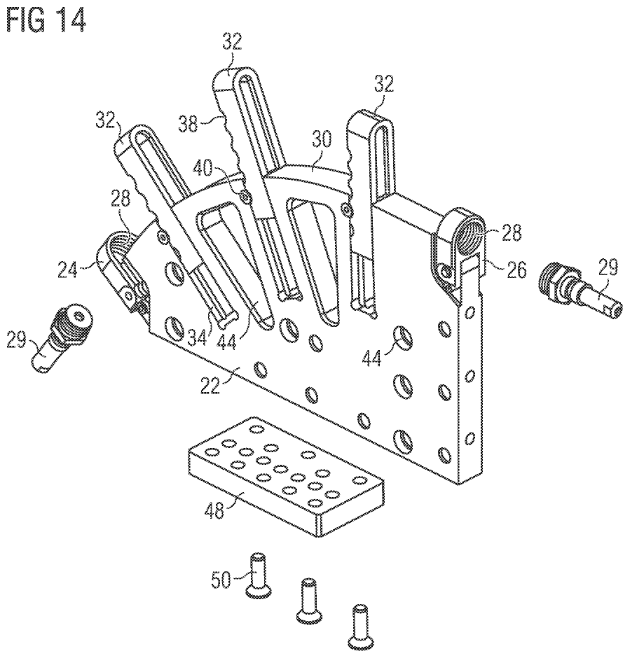

Attachment points 24, 26 are here formed as pivot attachments (please see in particular FIG. 14) which are pivotally connected to base 22. In this embodiment, the attachment points 24, 26 are provided with an internal thread 28 for a mechanical connection to the wire guide or to the master feeder. Connectors 29 are depicted here for the mechanical connection to these elements.

Buffer 20 comprises a curved guiding surface 30 which extends from the first attachment point 24 to the second attachment point 26. It serves for guiding the welding wire (depicted as welding wire 9 in FIGS. 4, 5 and 12, 13) when the welding wire is advanced from the container 2 towards the welding torch 5.

A tangent to the guiding surface 30 at the first attachment point 24 and a tangent to the guiding surface 30 and the second attachment point 26 include an angle α of approximately 45° (please see FIG. 4).

In FIG. 4, the condition of the buffer 20 during normal operation can be seen. The welding wire 9 is advanced in the direction of arrow A and slides over the guiding surface 30. The attachment points 24, 26 allow the connectors to orient themselves along the respective tangent to the guiding surface.

Should welding wire be pushed backwards into the guiding path (please see arrow B in FIG. 5), the resistance from the welding wire held in the upstream portion of the wire path together with the curved guiding surface results in the welding wire being lifted from the guiding surface 30 into the condition shown in

FIG. 5. The pivotable attachment points allow the welding wire guides to adjust their position so that there is a smooth curvature of the welding wire 9 (please see the arrows at the attachment points 24, 26).

FIG. 5 shows the condition for a length of 65 mm of welding wire being pushed backwards.

The base body 22 is formed such that a receiving space for the length of welding wire being pushed backwardly into the wire guide path is provided. The receiving space is delimited in the shown embodiment by a plurality of brackets 32 which have a U-shape and which are mounted with their free ends to the base body 22.

For each of the brackets 32, a receiving slot 34 is provided in the base body, with the orientation of each receiving slot 34 being perpendicular to a tangent to the guiding surface 30 at the point where the slot 34 intersects with the guiding surface 30.

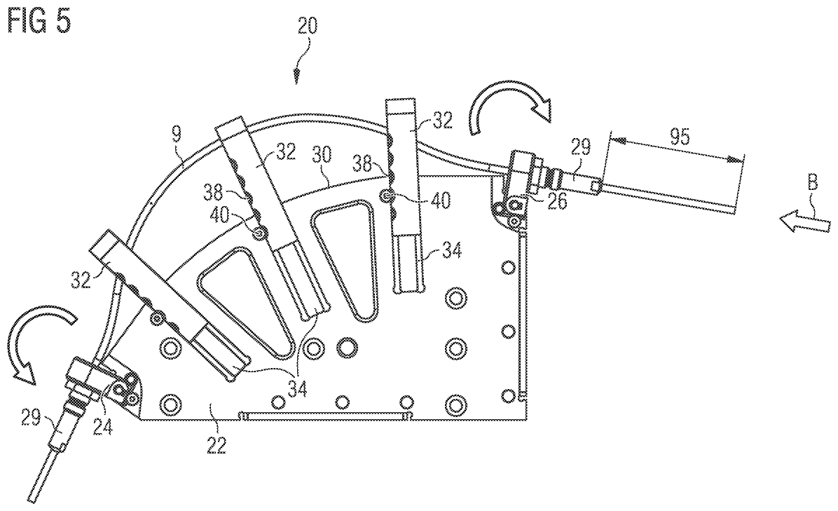

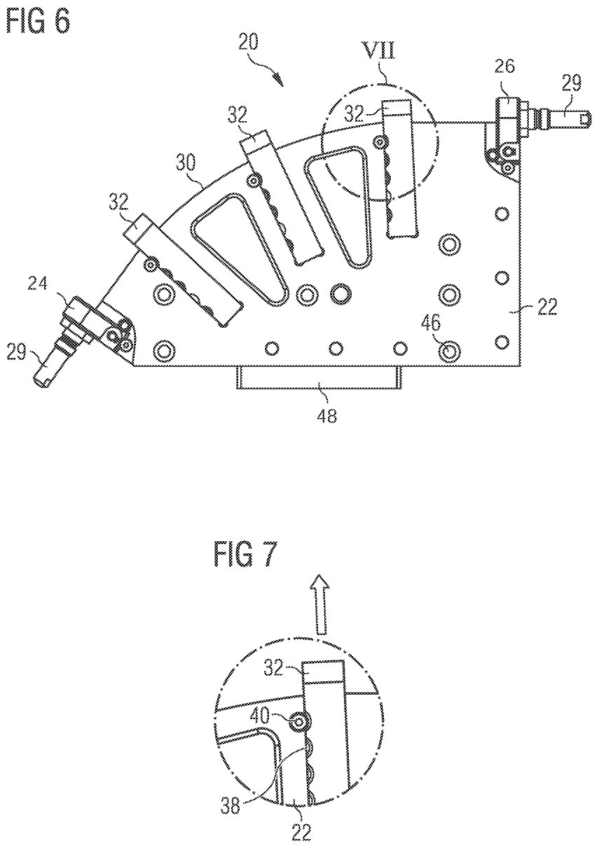

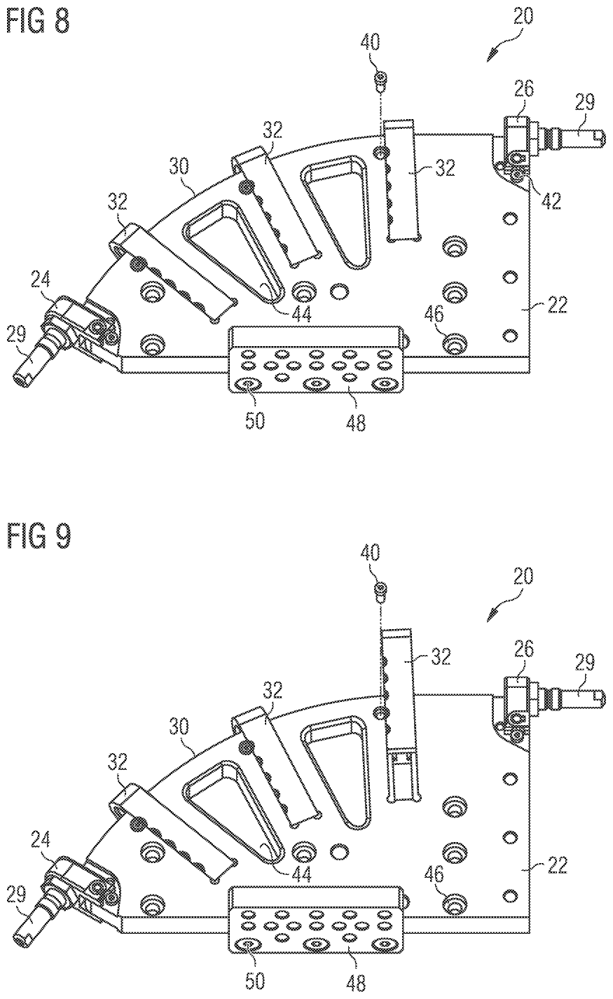

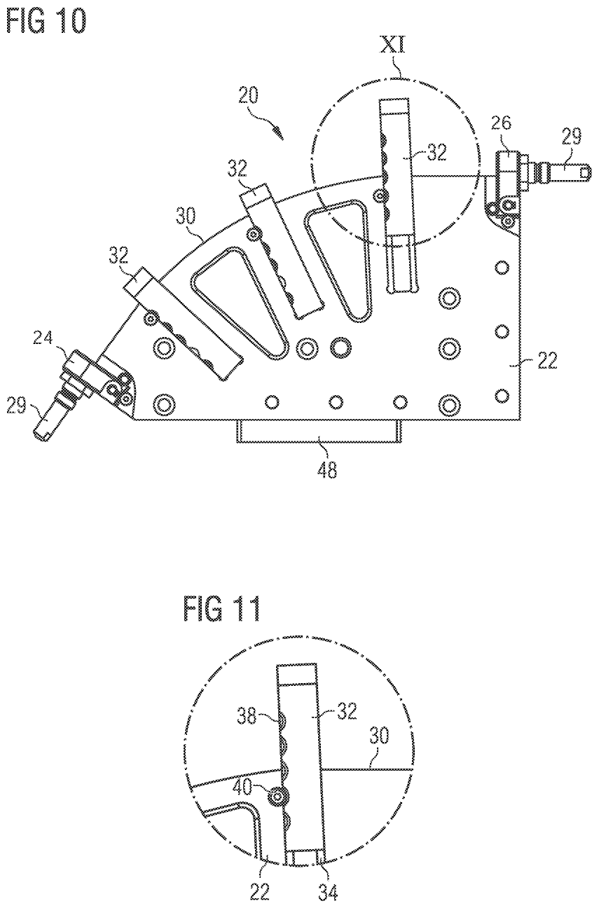

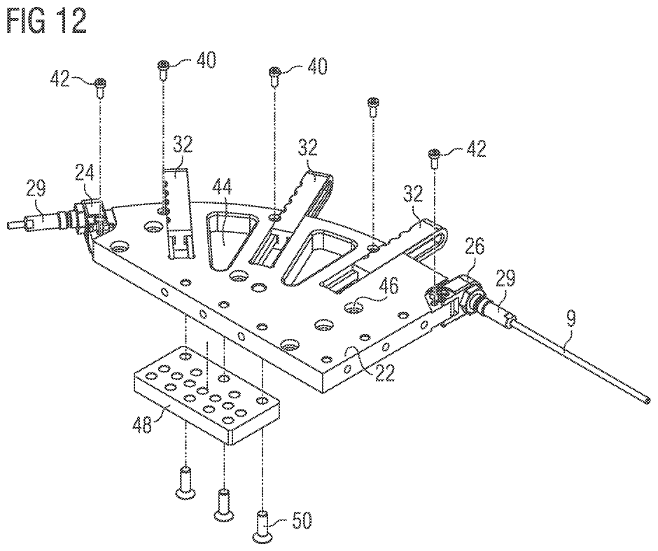

The brackets 32 are displaceable between a transport position (please see FIGS. 6 and 8) in which the apex of the brackets 32 are approached to the guiding surface 30, and an extended operating position (please see FIGS. 9 to 11 for one of the brackets and FIGS. 12 to 14) in which the apex of the bracket is in a distance from the guiding surface 30. In the extended position, a receiving space 36 for the welding wire 9 is delimited between the guiding surface 30, the opposing inner surfaces of the legs of the brackets 32, and the apex of the brackets.

Each bracket 32 can be locked in the transport position and one of a plurality of operating positions by means of a locking mechanism. The locking mechanism is here formed from a plurality of recesses 38 on one of the legs of the bracket 32, and a screw 40 which can be threaded into a thread in the base body 22.

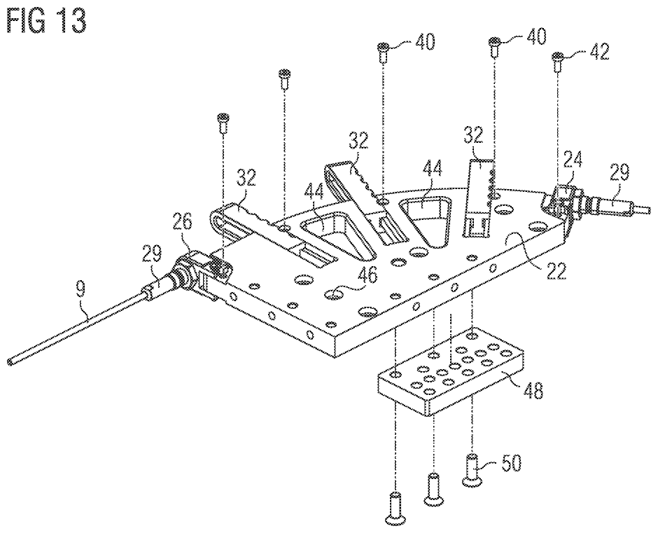

For restricting the pivot range of the attachment points 24, 26, a screw 2 can be threaded into the base body 22 (please see FIGS. 12 and 13).

Large openings 44 are provided in the base body 22 between receiving slots 34 so as to reduce the weight of the buffer 20.

The base body 22 can be mounted at a convenient location along the wire guiding path by means of mounting openings 46 provided in the base body, and by means of a mounting plate 48 which can be attached to the base body 22 in one of a plurality of positions with screws 50. In FIGS. 12 and 13, the mounting plate 48 is mounted to a side surface of the base body 22, and in FIG. 14, the mounting plate 48 is mounted to an end face of the base body 22.

A cover (not shown in the drawings) can be associated with the buffer 20 so that dust and other contaminations are prevented from entering into the wire guiding path. The cover can be formed from two shells which are clipped to each other and which enclose the buffer 20.

The effect of buffer 20 (providing a space within the wire guiding path into which a certain length of welding wire can pushed when the forward portion of the welding wire is being moved opposite to the normal advancing direction) can also be achieve with a construction which allows for an increase of the length of the wire guiding system.

Such construction can be based on a mechanism which replaces the buffer and instead allows at the location of the buffer that an additional length is being created. As an example and looking at the two connectors 29, the mechanism can receive one of the connectors 29 in a displaceable manner so that the connectors 29 can assume an operating position in which they are approached to each other, and a buffering position in which they are spaced from each other by the length of welding wire which has been pushed into the wire guiding system when welding wire is being retracted from the welding torch.

The mechanism can include a sliding guide for one of the connectors and a spring which biases the connectors into the operating position with a low pretension.

1. A welding wire supply system having a first wire feeder and a wire guide for guiding the welding wire to an automated welding system with a second wire feeder and a welding torch, the wire guide including a wire buffer arranged downstream of the first wire feeder, the wire buffer being adapted for receiving an additional length of welding wire in the path of the wire guide.

2. The welding wire feeding system of claim 1 wherein the buffer comprises a receiving space between two attachment points for a first and a second wire guide element.

3. The welding wire feeding system of claim 2 wherein the attachment points are pivot attachments for attaching the first and second wire guide elements.

4. The welding wire feeding system of claim 1 wherein the buffer comprises a guiding surface for guiding the welding wire when a traction force is present in the welding wire between the first and second attachment points.

5. The welding wire feeding system of claim 4 wherein the guiding surface is formed on a base body, the receiving space being defined by at least one bracket attached to the base body together with the guiding surface.

6. The welding wire feeding system of claim 5 wherein the bracket is adjustably attached to the base body.

7. The welding wire feeding system of claim 6 wherein a plurality of positions of the bracket relative to the base body is predefined by plurality of recesses in the bracket.

8. The welding wire feeding system of claim 6 wherein the bracket is attached to the base body by at least one screw.

9. The welding wire feeding system of claim 5 wherein three brackets are evenly arranged between the attachment points for the first and second wire guide element.

10. The welding wire feeding system of claim 1 wherein the buffer comprises a slide allowing adjacent ends of the first and second wire guide elements to move from an approached working position to a spaced buffering position.

11. The welding wire feeding system of claim 1 wherein the buffer comprises a cover which prevents dust from entering into the wire path.

12. The welding wire feeding system of claim 1 wherein the buffer comprises mounting openings for mounting the base body in one of at least two positions.

13. The welding wire feeding system of claim 1 wherein the first wire feeder is associated with a welding wire container.

14. The welding wire feeding system of claim 1 wherein the first wire feeder is a passive wire feeder.

15. The welding wire feeding system of claim 1 wherein the first wire feeder is a passive “stand-alone” wire feeder equipped with an electrical motor to operate the wire pushing wheels.

16. The welding wire feeding system of claim 1 wherein the first wire feeder is a “pneumatic” passive “stand-alone” wire feeder which utilizes compressed air to operate the wire pushing wheels.

17. A welding wire supply system having a first wire feeder and a wire guide for guiding the welding wire to an automated welding system with a second wire feeder and a welding torch, the wire guide including a wire buffer arranged downstream of the first wire feeder, the wire buffer being adapted for receiving an additional length of welding wire in the path of the wire guide, the buffer having a base body with a curved guiding surface for the welding wire, and a first attachment point for a connector at one end of the guiding surface, and a second attachment point for a connector at the other end of the guiding surface, at least one of the attachment points being adapted for attaching the connector to the base body in a pivotable manner.
